(19) United States
(12) Patent Application Publication
(10) Pub. No.: US 2024/0028981 A1
(43) Pub. Date: Jan. 25, 2024

(54) SYSTEM AND METHOD FOR AUTOMATED RESOURCE REQUEST EVALUATIONS

(71) Applicant: HARTFORD FIRE INSURANCE COMPANY, HARTFORD, CT (US)

(72) Inventors: Gary S. Tomchik, Houston, TX (US); Courtney E. Servidone, Baldwinsville, NY (US); Anna K. Bondyra, Glastonbury, CT (US)

(21) Appl. No.: 17/869,231

(22) Filed: Jul. 20, 2022

(51) Int. Cl. G06Q 10/06; G06Q 40/08

(52) U.S. Cl. CPC G06Q 10/0631; G06Q 40/08

(57) ABSTRACT

A resource request data store contains electronic records connected to risk relationships with an enterprise (each record may represent a resource request and include a resource request identifier and request characteristics). A back-end application computer server retrieves request characteristics associated with a resource request for a first party. Based on the request characteristics and business rules, the server determines if the resource request for the first party should be immediately assigned to a request handler. If the request is not to be immediately assigned, the server arranges for the first party to answer a dynamic series of questions. Based on answers provided by the first party and a set of investigation rules, automatically determine if the resource request for the first party should be assigned to the request handler or to a specialist to investigate whether another enterprise may be responsible for responding to the resource request, the system utilizes a machine learning algorithm to evaluate resource requests currently assigned to the request handler to determine if any of those resource requests should instead be routed to the specialist. The resource request is then routed to a request handler or the specialist.

### TECHNICAL FIELD

The present application generally relates to computer systems and more particularly to computer systems that are adapted to accurately and/or automatically evaluate resource requests for an enterprise.

### BACKGROUND

An enterprise may enter into risk relationships with other parties and respond to resource request. For example, an insurer may arrange to issue insurance policies and provide payments when insurance claim requests satisfy certain requirements. FIG. 1 illustrates some examples of 100 enterprise 110 relationships. In some cases, the enterprise 110 may issue policies directly to the parties 120 (e.g., automobile insurance policies) while in other cases, the enterprise 110 may cover parties through entities 130, 140 such as employers. For example, the enterprise 110 may process workers' compensation insurance claims for parties A2 through AN associated with entity A 130. In that situation, party A1 may submit information about the claim to entity A 130 who, in turn, provides the information to the enterprise 110. In other cases, party 1 may submit information about the claim directly to the enterprise 110 (as illustrated by the dashed arrow in FIG. 1).

Note another enterprise 112 may also be wholly or partially responsible for responding to a resource request. For example, in the case of an automobile accident involving two vehicles the insurance companies representing both vehicles may be responsible for providing payments in response to insurance claims. As used herein, the phrase “insurance subrogation” may refer to a right held by an insurer carriers to legally pursue another party associated with an insurance loss to an insured (in order to recover at least some of the amount of the claim paid by the insurer). Typically, when an insurer receives a First Notice Of Loss (“FNOL”) about an insurance claim it may apply business rules to determine if there is “Potential Third-Party Involvement” when the claim is assigned to a claim handler in real time. The claim handler investigates whether subrogation is likely given the facts of the case and, if so, forwards information about the claim to a subrogation specialist. The subrogation specialist reviews the claim handler's investigation and asks the claim handler to obtain any missing information (or may directly request information from the involved parties). The specialist can then resolve the subrogation and secure any appropriate recoveries. Such an approach, however, can be a time-consuming process—especially when a substantial number of claims are received.

It would therefore be desirable to provide improved systems and methods to accurately and/or automatically perform resource request evaluations for an enterprise. Moreover, the results should be easy to access, understand, interpret, update, etc.

### SUMMARY OF THE INVENTION

According to some embodiments, systems, methods, apparatus, computer program code and means are provided to accurately and/or automatically perform resource request evaluations for an enterprise in a way that provides fast, efficient, and useful results and that allows for flexibility and effectiveness when responding to those results.

Some embodiments are directed to a resource request evaluation system implemented via a back-end application computer server. A resource request data store contains electronic records connected to risk relationships with an enterprise (each record may represent a resource request and include a resource request identifier and request characteristics). A back-end application computer server retrieves request characteristics associated with a resource request for a first party. Based on the request characteristics and business rules, the server determines if the resource request for the first party should be immediately assigned to a request handler. If the request is not to be immediately assigned, the server arranges for the first party to answer a dynamic series of questions. Based on answers provided by the first party and a set of investigation rules, automatically determine if the resource request for the first party should be assigned to the request handler or to a specialist to investigate whether another enterprise may be responsible for responding to the resource request, the system utilizes a machine learning algorithm to evaluate resource requests currently assigned to the request handler to determine if any of those resource requests should instead be routed to the specialist. The resource request is then routed to a request handler or the specialist.

Some embodiments comprise: means for retrieving, by a computer processor of a back-end application computer server from a resource request data store, request characteristics associated with a resource request for a first party, wherein the resource request data store contains electronic records connected to risk relationships with an enterprise, and each electronic record represents a resource request and includes a resource request identifier and a plurality of request characteristics; based on the request characteristics and an initial set of business rules, means for automatically determining if the resource request for the first party should be immediately assigned to a request handler; if the resource request is not to be immediately assigned to the request handler, means for arranging for the first party to answer a dynamic series of questions about the resource request; based on answers provided by the first party and a set of investigation rules, means for automatically determining if the resource request for the first party should be assigned to the request handler or to a specialist to investigate whether another enterprise may be responsible for responding to the resource request; means for utilizing a machine learning algorithm to evaluate resource requests currently assigned to the request handler to automatically determine if any of those resource requests should instead be routed to the specialist; and means for routing the resource request to at least one of the request handler and the specialist.

In some embodiments, a communication device associated with a back-end application computer server exchanges information with remote devices in connection with an interactive graphical resource request evaluation interface. The information may be exchanged, for example, via public and/or proprietary communication networks.

A technical effect of some embodiments of the invention is an improved and computerized way to accurately and/or automatically perform resource request evaluations for an enterprise in a way that provides fast, efficient, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates enterprise relationships.

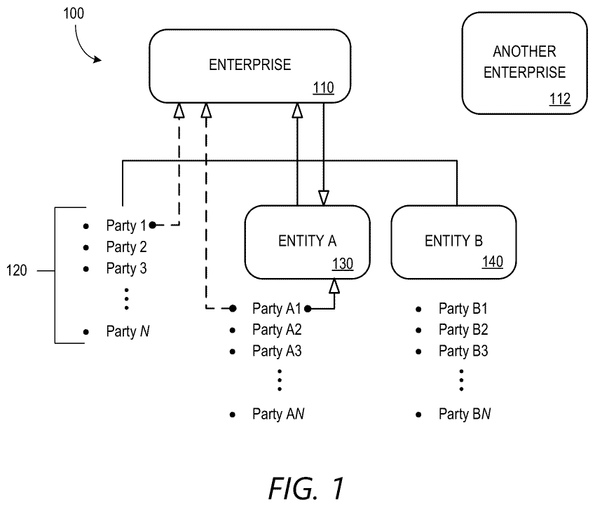

FIG. 2 is a high-level block diagram of a resource request evaluation system in accordance with some embodiments.

FIG. 3 illustrates a resource request evaluation method according to some embodiments of the present invention.

FIG. 4 is high-level claim request evaluation solution in accordance with some embodiments.

FIG. 5 illustrates subrogation automation workflows according to some embodiments.

FIG. 6 illustrates a subrogation key performance indicators display in accordance with some embodiments.

FIG. 7 illustrates a system associated with machine learning and a predictive model according to some embodiments.

FIG. 8 is a subrogation method in accordance with some embodiments.

FIG. 9 is an example of subrogation identification questions according to some embodiments.

FIG. 10 is a block diagram of an apparatus in accordance with some embodiments of the present invention.

FIG. 11 is a portion of a resource request data store according to some embodiments.

FIG. 12 illustrates a resource request administrator or operator display in accordance with some embodiments.

FIG. 13 illustrates a smartphone display according to some embodiments.

FIG. 14 illustrates a handheld tablet display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data availability, consistency, and analytics associated with a resource request evaluation system. The present invention is directed to more than merely a computer implementation of a routine or conventional activity previously known in the industry as it provides a specific advancement in the area of electronic record availability, consistency, and analysis by providing improvements in the operation of a computer system that uses machine learning and/or predictive models to implement a resource request evaluation. The present invention provides improvement beyond a mere generic computer implementation as it involves the novel ordered combination of system elements and processes to provide improvements in the speed at which such data can be made available and consistent results. Some embodiments of the present invention are directed to a system adapted to automatically determine resource request information, analyze electronic records, aggregate data from multiple sources including text mining, determine appropriate subrogation information, etc. Moreover, communication links and messages may be automatically established (e.g., to provide information to a claimant, claim handler, subrogation specialist), aggregated, formatted, exchanged, etc. to improve network performance (e.g., by reducing an amount of network messaging bandwidth and/or storage required to support resource request evaluation).

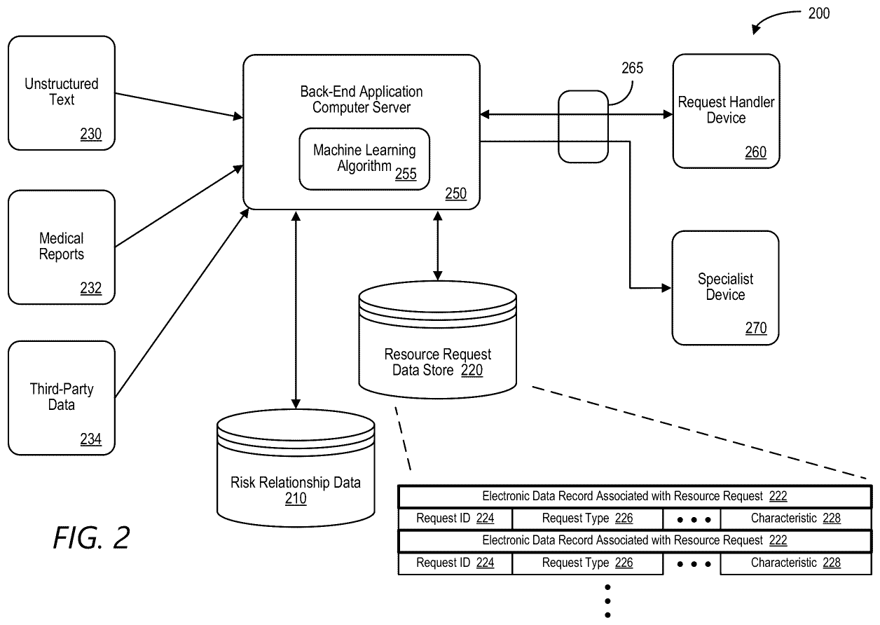

According to some embodiments, an enterprise may receive and evaluate resource requests. For example, FIG. 2 is a high-level block diagram of a resource request evaluation system 200 according to some embodiments of the present invention. In particular, the system 200 includes a back-end application computer server 250 that may access a risk relationship data 210 and information in a resource request data store 220 (e.g., storing a set of electronic records associated with resource requests, each record including, for example, one or more request identifiers 224, request types 226, request characteristics 228, etc.). The back-end application computer server 250 may also store information into other data stores and utilize a Graphical User Interface (“GUI”) and machine learning algorithm 255 to view, analyze, and/or update the electronic records. The back-end application computer server 250 may also exchange information with a remote request handler device 260 and specialist device 270 (e.g., via a firewall 265). According to some embodiments, unstructured text 230 (e.g., from incident reports), data from medical reports 232 (e.g., automatically collected by the back-end application computer server 250 via communication links), and/or third-party data 234 (e.g., police reports) may be aggregated, analyzed, and provided to the remote resource request devices 260, 270. In some embodiments, the request handler device 260 may transmit annotated and/or updated information to the back-end application computer server 250. Based on the updated information, the back-end application computer server 250 may adjust data in the resource request data store 220 and/or the change may be viewable via the specialist device 270. Note that the back-end application computer server 250 and/or any of the other devices and methods described herein might be associated with a third party, such as a vendor that performs a service for an enterprise.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records. As used herein, the term “automated” may refer to, for example, actions that can be performed with little (or no) intervention by a human.

As used herein, devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the resource request data store 220. The data store 220 may be locally stored or reside remote from the back-end application computer server 250. As will be described further below, the resource request data store 220 may be used by the back-end application computer server 250 in connection with a resource request evaluation. Although a single back-end application computer server 250 is shown in FIG. 2, any number of such devices may be included. Moreover, various devices described herein might be combined according to embodiments of the present invention. For example, in some embodiments, the back-end application computer server 250 and the resource request data store 220 might be co-located and/or may comprise a single apparatus and/or be implemented via a cloud-based computing environment.

In this way, embodiments may provide the potential for increased subrogation recovery due to specialization and reduce back and forth follow-ups between a claim handler and a subrogation specialist. Embodiments may also potentially reduce the number of customer contacts needed to investigate subrogation and give the enterprise greater control over process and/or quality consistency by utilizing specialists.

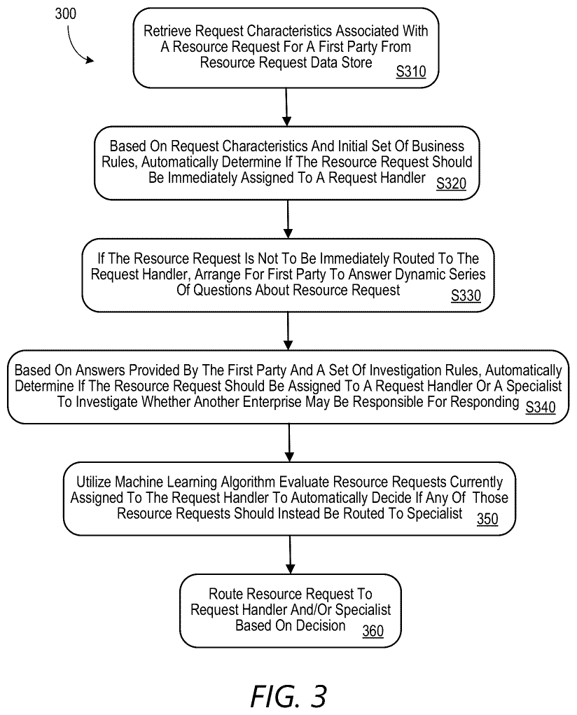

Note that the system 200 of FIG. 2 is provided only as an example, and embodiments may be associated with additional elements or components. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of a back-end application computer server may retrieve (from a resource request data store) request characteristics associated with a resource request for a first party. The resource request data store may, for example, contain electronic records connected to risk relationships with an enterprise (e.g., insurance policies of an insurer), and each electronic record represents a resource request (e.g., a workers' compensation insurance claim) and includes a resource request identifier and a plurality of request characteristics (e.g., information about an insurance claim). Examples of resource request characteristics may include, for example, a first party identifier (e.g., a claimant name and communication link), a risk relationship identifier (e.g., an insurance policy number, and Claim Description Code (“CDC”), etc. The retrieval performed by the back-end application might be associated with the non-digital FNOL intake process or a digital FNOL intake process. Although some embodiments are described with respect to workers' compensation insurance, not that embodiments might instead be associated with automobile insurance, property insurance, group benefits insurance, general liability insurance, etc.

Based on the request characteristics and an initial set of business rules, at S320 the system may automatically determine if the resource request for the first party should be immediately assigned to a request handler. The initial set of business rules might be associated with, for example, a motor vehicle accident insurance claim, a slip or fall insurance claim, an insurance claim involving a third-party, an insurance claim involving machinery, etc.

At S330, if the resource request is not to be immediately assigned to the request handler, the system may arrange for the first party to answer a dynamic series of questions about the resource request. The series of questions may be “dynamically adjusted,” for example, based on request characteristics and answers provided by the first party (e.g., answering one question in a certain way might cause additional questions to be inserted into the series).

Based on answers provided by the first party and a set of investigation rules, at S340 the system may automatically determine if the resource request for the first party should be assigned to the request handler or to a specialist to investigate whether another enterprise may be responsible for responding to the resource request. In some embodiments, the set of investigation rules will categorize the resource request as either “likely subrogation,” “potential subrogation,” or “no subrogation.” In this case, a resource requests categorized as “likely subrogation” or “potential subrogation” might be routed to an insurance subrogation specialist.

At S350, the system may utilize a “machine learning” algorithm to evaluate resource requests currently assigned to the request handler to automatically determine if any of those resource requests should instead be routed to the specialist (e.g., as a “backstop” to identify some additional potential subrogation situations). As used herein, the phrase “machine learning” may refer to artificial intelligence techniques including methods that “learn” (leveraging data to improve performance for a given task). For example, a machine learning algorithm may build a model based on sample data (known as training data) to make predictions or decisions.

At S360, the resource request may be routed to at least one of the request handler and/or the specialist as appropriate. Moreover, in some embodiments, a communication port coupled to the back-end application computer server may facilitate an exchange of data with a remote resource request device to support an interactive graphical resource request display via a distributed communication network. According to some embodiments, interactive graphical resource request display may include a referral rate, a success rate, a recovery rate, an expense ratio, a subrogation rate, graphical trend information, etc.

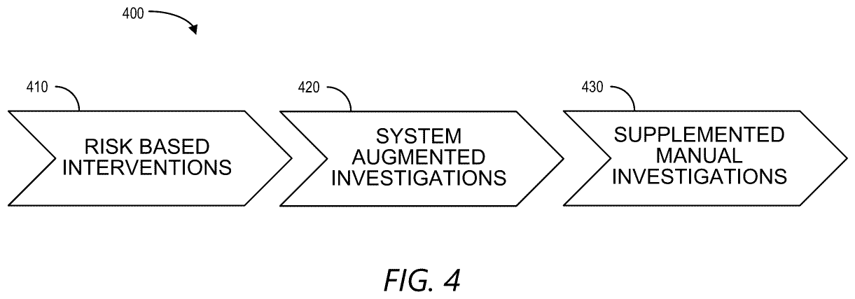

FIG. 4 is high-level claim request evaluation solution 400 in accordance with some embodiments. In particular, the solution 400 may begin with risk-based interventions 410 that use initial rules to flag claims based on the CDC when the FNOL is received. For example, the initial rules may look for motor vehicle accidents, slip or fall incidents, machinery injuries, third-party involvement, etc. (and between 5% and 25% of received claims might be flagged). Next, system augments investigations 420 may be performed using templated subrogation questions and system augmented decisions. Finally, supplemented manual investigations 430 may be performed such that potential subrogation claims are flagged for manual investigation (e.g., via business rules and/or data science models (and approximately 15% of claims may be flagged for manual investigation.

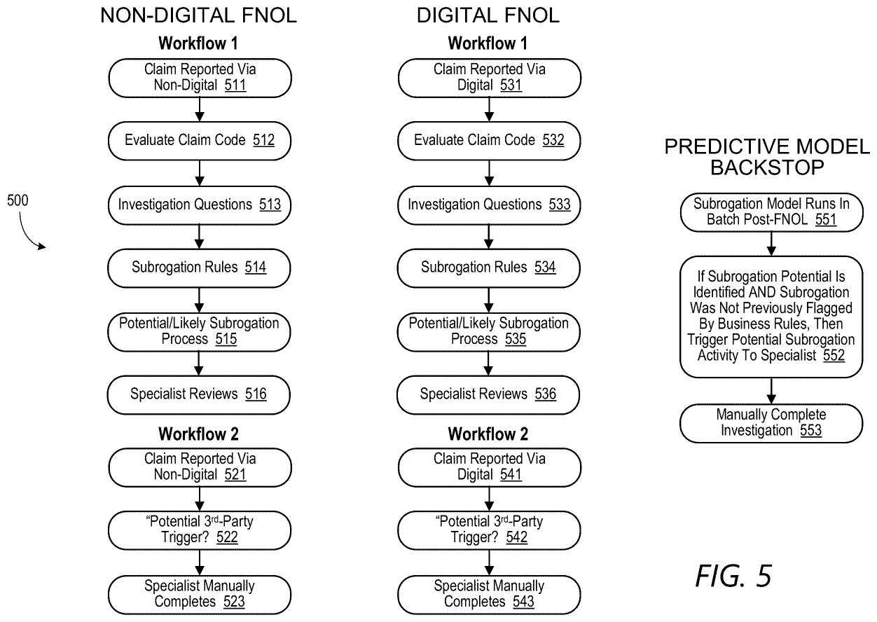

FIG. 5 illustrates subrogation automation workflows 500 according to some embodiments. If a FNOL is received via a non-digital intake process at 511 (e.g., a telephone call from a claimant), a first workflow may evaluate a Claim Description Code (“CDC”) assigned to the claim at 512. For example, if the If CDC=“Motor Vehicle Accident” (“MVA”), “Slip/Fall”, or “Machinery,” the system may trigger one or more subrogation investigation questions to a claim reporter. The customer may then complete the investigation questions digitally (e.g., via a web page) at 513 and subrogation decision rules may be applied at 514. The subrogation decision rules may provide, for example, an outcome of “Likely Subrogation,” “Potential Subrogation,” or “No Subrogation.” If the outcome is “Potential Subrogation” or “Likely Subrogation” at 515, a subrogation screen may be created for a claim review display along with a trigger to refer the claim to an insurance subrogation specialist. The subrogation specialist may then review the answers and complete the investigation at 516. If a FNOL is received via a non-digital intake process at 521 (e.g., a telephone call from a claimant), a second workflow may determine if there is a “Potential Third-Party” at 522. If so, the system may trigger a referral to engage an insurance subrogation specialist at 522, and the subrogation specialist may then manually complete the subrogation investigation at 523.

If a FNOL is received via a digital intake process at 531 (e.g., a web page), a first workflow may evaluate a CDC assigned to the claim at 532. For example, if the If CDC=“Motor Vehicle Accident” (“MVA”), “Slip/Fall”, or “Machinery,” the system may present one or more subrogation investigation questions via the digital interface for the customer to answer at 533. Subrogation decision rules may be applied at 534 resulting in an outcome of “Likely Subrogation,” “Potential Subrogation,” or “No Subrogation.” If the outcome is “Potential Subrogation” or “Likely Subrogation” at 535, a subrogation screen may be created for a claim review display along with a trigger to refer the claim to an insurance subrogation specialist. The subrogation specialist may then review the answers and complete the investigation at 536. If a FNOL is received via a digital intake process at 541 (e.g., a web page), a second workflow may determine if there is a “Potential Third-Party” at 542 (and the CDC is not “MV,” “Slip/Fall,” or “Machinery”). If so, the system may trigger a referral to engage an insurance subrogation specialist at 542, and the subrogation specialist may then manually complete the subrogation investigation at 543.

A predictive model backstop may begin at 551 by executing a batch process on post-FNOL claims. If subrogation potential is identified and subrogation has not been previously flagged by business rules, the system may trigger a potential subrogation activity to an insurance subrogation specialist at 552. The subrogation specialist may then manually complete the subrogation investigation at 553.

According to some embodiments, the subrogation specialist asks an individual who reported a claim an appropriate question set (based on the CDC) via email. The system may evaluate the performance of the question set based on, for example, an average turn-around time for the question set, efficacy, system decision accuracy, specialist efficiency impacts, customer service impacts, potential subrogation leakage, etc. The system may then provide for an automatic refinement of the question set (by adjusting the ordering and/or phrasing of particular questions).

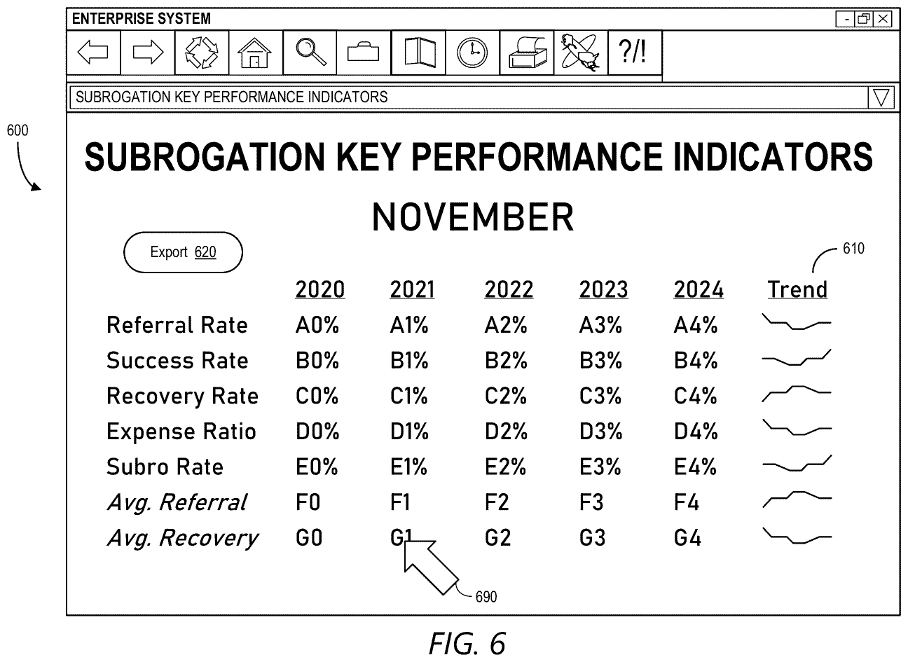

In some embodiments, a claim evaluation system may provide displays to monitor performance. For example, FIG. 6 illustrates a subrogation key performance indicators display 600 in accordance with some embodiments. The display 600 includes a table 610 that provides numerical values and a graphical trend line for a claim referral rate (e.g., a total number of claim closures divided by claim intake) and a success rate (e.g., a number of claims closed with recoveries divided by all claims closed). The table 610 may also provide a recovery rate (e.g., the gross life of claim recovery divided by loss paid), an expense ratio (e.g., recovery expenses divided by gross recovery), a subrogation rate (e.g., a gross life of claim recovery divided by a gross loss paid for all claims), an average referral (e.g., a subrogation dollar amount of referrals divided by claims referred to subrogation), an average recovery (e.g., a gross recovery divided by claims closed with a recovery), graphical trend information, etc. Selection of a portion of the table (e.g., via a touchscreen or computer mouse pointer 690) may result in the display of additional details about that portion. Selection of an “Export” icon 620 may save the data in a particular format (e.g., a spreadsheet).

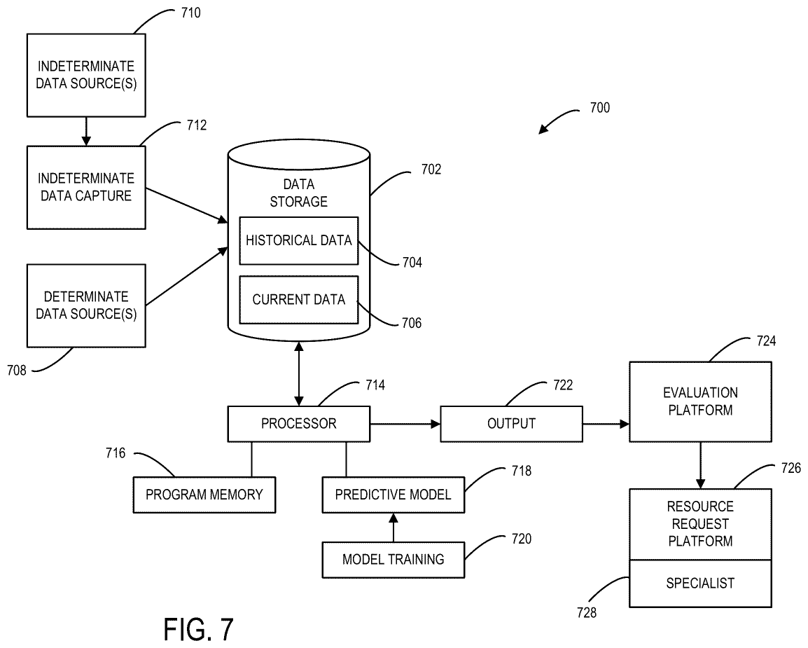

According to some embodiments, machine learning and/or one or more predictive models may be used to evaluate claim subrogation based on prior events and claims. Features of some embodiments associated with a predictive model will now be described by first referring to FIG. 7. FIG. 7 is a partially functional block diagram that illustrates aspects of a computer system 700 provided in accordance with some embodiments of the invention. For present purposes, it will be assumed that the computer system 700 is operated by an insurance company (not separately shown) to support resource request evaluation monitoring and processing.

The computer system 700 includes a data storage module 702. In terms of its hardware the data storage module 702 may be conventional, and may be composed, for example, of one or more magnetic hard disk drives. A function performed by the data storage module 702 in the computer system 700 is to receive, store and provide access to both historical claim transaction data (reference numeral 704) and current claim transaction data (reference numeral 706). As described in more detail below, the historical claim transaction data 704 is employed to train a predictive model to provide an output that indicates potential subrogation, and the current claim transaction data 706 is thereafter analyzed by the predictive model. Moreover, as time goes by, and results become known from processing current claim transactions, at least some of the current claim transactions may be used to perform further training of the predictive model. Consequently, the predictive model may thereby adapt itself to changing event impacts and subrogation results.

Either the historical claim transaction data 704 or the current claim transaction data 706 might include, according to some embodiments, as determinate and indeterminate data. As used herein, “determinate data” refers to verifiable facts such as an employer; a claimant; a claim type (e.g., slip and fall); a date of loss, or date of report of claim, or policy date or other date; a time of day; a day of the week; a geographic location, an address or ZIP code; a policy number; etc.

As used herein, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes or accident reports might be associated with, for example, an amount of loss and/or details about damages.

The determinate data may come from one or more determinate data sources 708 that are included in the computer system 700 and are coupled to the data storage module 702. The determinate data may include “hard” data like a claimant's name, tax identifier umber, policy number, address; the date of loss; the date the claim was reported, etc. One possible source of the determinate data may be the insurance company's policy database (not separately indicated). Another possible source of determinate data may be from data entry by the insurance company's claims intake administrative personnel.

The indeterminate data may originate from one or more indeterminate data sources 710 and may be extracted from raw files or the like by one or more indeterminate data capture modules 712. Both the indeterminate data source(s) 710 and the indeterminate data capture module(s) 712 may be included in the computer system 700 and coupled directly or indirectly to the data storage module 702. Examples of the indeterminate data source(s) 710 may include data storage facilities for document images, for text files (e.g., claim handlers' notes), digitized recorded voice files (e.g., claimants' oral statements, witness interviews, claim handlers' oral notes, etc.), streams of video information, etc. Examples of the indeterminate data capture module(s) 712 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual. For example, claim handlers' opinions may be extracted from their narrative text file notes.

The computer system 700 also may include a computer processor 714. The computer processor 714 may include one or more conventional microprocessors and may operate to execute programmed instructions to provide functionality as described herein. Among other functions, the computer processor 714 may store and retrieve historical claim transaction data 704 and current claim transaction data 706 in and from the data storage module 702. Thus, the computer processor 714 may be coupled to the data storage module 702.

The computer system 700 may further include a program memory 716 that is coupled to the computer processor 714. The program memory 716 may include one or more fixed storage devices, such as one or more hard disk drives, and one or more volatile storage devices, such as RAM devices. The program memory 716 may be at least partially integrated with the data storage module 702. The program memory 716 may store one or more application programs, an operating system, device drivers, etc., all of which may contain program instruction steps for execution by the computer processor 714.

The computer system 700 further includes a predictive model component 718. In certain practical embodiments of the computer system 700, the predictive model component 718 may effectively be implemented via the computer processor 714, one or more application programs stored in the program memory 716, and data stored as a result of training operations based on the historical claim transaction data 704 (and possibly also data received from a third-party reporting service). In some embodiments, data arising from model training may be stored in the data storage module 702, or in a separate data store (not separately shown). A function of the predictive model component 718 may be to determine appropriate simulation models, results, and/or scores (e.g., a rating indicating a likelihood of subrogation). The predictive model component may be directly or indirectly coupled to the data storage module 702.

The predictive model component 718 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 700 includes a model training component 720. The model training component 720 may be coupled to the computer processor 714 (directly or indirectly) and may have the function of training the predictive model component 718 based on the historical claim transaction data 704 and/or information about subrogation events, incidents, and alerts. (As will be understood from previous discussion, the model training component 720 may further train the predictive model component 718 as further relevant data becomes available.) The model training component 720 may be embodied at least in part by the computer processor 714 and one or more application programs stored in the program memory 716. Thus, the training of the predictive model component 718 by the model training component 720 may occur in accordance with program instructions stored in the program memory 716 and executed by the computer processor 714.

In addition, the computer system 700 may include an output device 722. The output device 722 may be coupled to the computer processor 714. A function of the output device 722 may be to provide an output that is indicative of (as determined by the trained predictive model component 718) subrogation likelihood, events, insurance underwriting parameters, and recommendations. The output may be generated by the computer processor 714 in accordance with program instructions stored in the program memory 716 and executed by the computer processor 714. More specifically, the output may be generated by the computer processor 714 in response to applying the data for the current simulation to the trained predictive model component 718. The output may, for example, be a monetary estimate, a risk level, and/or likelihood within a predetermined range of numbers. In some embodiments, the output device may be implemented by a suitable program or program module executed by the computer processor 714 in response to operation of the predictive model component 718.

Still further, the computer system 700 may include a monitoring platform 724. The monitoring platform 724 may be implemented in some embodiments by a software module executed by the computer processor 714. The monitoring platform 724 may have the function of rendering a portion of the display on the output device 722. Thus, the monitoring platform 724 may be coupled, at least functionally, to the output device 722. In some embodiments, for example, the monitoring platform 724 may direct workflow by referring, to resource request platform 726, subrogation recommendations and/or alerts generated by the predictive model component 718 and found to be associated with various results or scores. In some embodiments, this data may be provided to a specialist 728 (e.g., via an automatically established communication link) who may investigate insurance claims as appropriate.

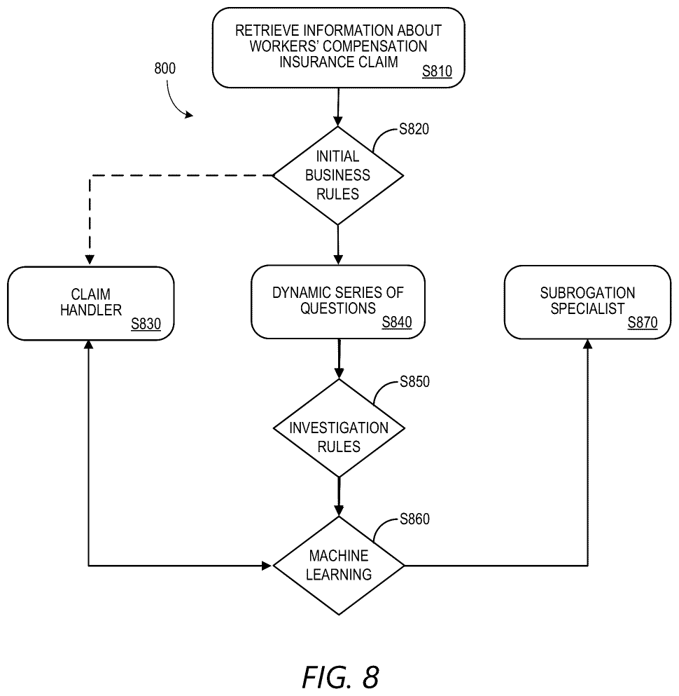

FIG. 8 is a subrogation method 800 that utilizes machine learning rules in accordance with some embodiments. At S810, the system retrieves information about a workers' compensation claim. An initial set of business rules are applied at S820 and, based on the outcome of those rules, a referral may be made to a claim handler at S830 as illustrated by a dashed arrow in FIG. 8 (e.g., if it seems highly unlikely that a subrogation investigation is warranted). If not, a dynamic series of questions are provided to the claimant at S840, and investigation rules are applied to the answers provided by the claimant at S850. At this point, the investigation rules might assign the claim to the claim handler S830 or a subrogation specialist S870. At S860, a machine learning algorithm is applied to evaluate resource requests that are currently assigned to the claim handler S830 (as a last effort to identify potential subrogation). Based on the outcome of that algorithm, a referral may be made to the subrogation specialist at S870. If not, the claim is routed to claim handler at S820 for regular workers' compensation processing (that is, there will be no further subrogation investigation).

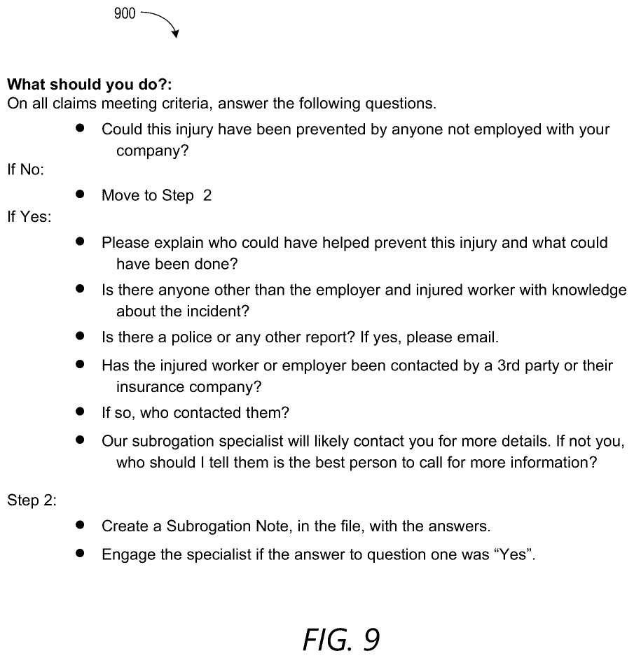

FIG. 9 is an example of subrogation identification questions 900 according to some embodiments. The questions 900 might be provided, for example, for claims where a subrogation question set is not present in FNOL response and the answer to the question “Was there a 3rd party responsible” was “Yes,” “Unknown,” or “Blank.” The claimant may be asked “Could this injury have been prevented by anyone not employed with your company?” If yes, the questions may include asking who could have helped prevent this injury, if there is anyone other than the employer and injured worker with knowledge about the incident, if there is a police (or any other) report, etc.

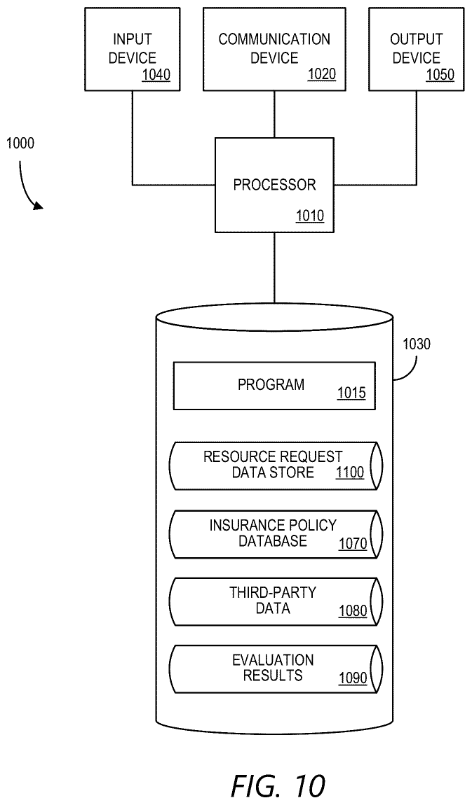

The embodiments described herein may be implemented using any number of different hardware configurations. For example, FIG. 10 illustrates an apparatus 1000 that may be, for example, associated with the system 200 described with respect to FIG. 2. The apparatus 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote resource request devices (e.g., PCs and smartphones), administrator computers, and/or third-party platforms. Note that data exchanged via the communication device 1020 may utilize security features, such as encryption between an insurance company server and resource request devices. The security features might be associated with, for example, web servers, firewalls, and/or PCI infrastructure. The apparatus 1000 further includes an input device 1040 (e.g., a mouse and/or keyboard to enter information about subrogation questions, rules, etc.) and an output device 1050 (e.g., to output reports regarding resource request evaluations, summary logs, recommended actions, alerts, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or a resource request evaluation tool or application for controlling the processor 1010. The processor 1010 performs instructions of the program 1015, and thereby operates in accordance with any of the embodiments described herein. For example, the processor 1010 may retrieve request characteristics associated with a resource request for a first party. Based on the request characteristics and business rules, the processor 1010 may determine if the resource request for the first party should be immediately assigned to a request handler. If the request is not to be immediately assigned, the processor 1010 may arrange for the first party to answer a dynamic series of questions. Based on answers provided by the first party and a set of investigation rules, automatically determine if the resource request for the first party should be assigned to the request handler or to a specialist to investigate whether another enterprise may be responsible for responding to the resource request, the processor 1010 may utilize a machine learning algorithm to evaluate resource requests currently assigned to the request handler to determine if any of those resource requests should instead be routed to the specialist. The resource request may then be routed to a request handler or the specialist.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

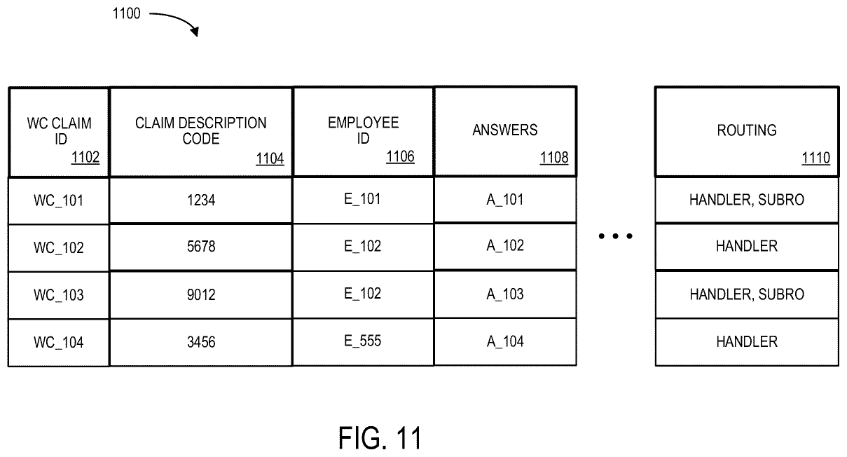

In some embodiments (such as shown in FIG. 10), the storage device 1030 further stores a resource request data store 1100 (e.g., associated with resource request evaluations), an insurance policy database 1070, third-party data 1080, and evaluation results 1090 (e.g., indicating subrogation likelihood and/or investigation results). An example of a database that might be used in connection with the apparatus 1000 will now be described in detail with respect to FIG. 11. Note that the database described herein is only an example, and additional and/or different information may be stored therein. Moreover, various databases might be split or combined in accordance with any of the embodiments described herein. For example, the resource request data store 1100 and evaluation results 1090 might be combined and/or linked to each other within the program 1015.

Referring to FIG. 11, a table is shown that represents the resource request data store 1100 that may be stored at the apparatus 1000 according to some embodiments. The table may include, for example, entries associated with a resource request evaluation. The table may also define fields 1102, 1104, 1106, 1108, 1110 for each of the entries. The fields 1102, 1104, 1106, 1108, 1110 may, according to some embodiments, specify: workers' compensation claim identifier 1102, a claim description code 1104, an employee identifier 1106, answers 1108, and routing 1110. The resource request data store 1100 may be created and updated, for example, based on information electrically received from various data sources (e.g., including when new claim is added during a FNOL intake procedure, a subrogation evaluation is performed, etc.).

The workers' compensation claim identifier 1102 may be, for example, a unique alphanumeric code identifying a request from an employee who suffered a work-related injury or sickness. The claim description code 1104 may indicate how the injury occurred (e.g., in a motor vehicle accident, slip and fall, etc.). The employee identifier 1106 may identify the claimant and the answers 1108 may indicate how he or she responded to a dynamic series of subrogation related questions. The routing 1110 may indicate who received information about the claim for follow-up activities (e.g., a claim handler and/or subrogation specialist).

Thus, embodiments may provide an automated and efficient way to perform a resource request evaluations. This may lead to improved subrogation recovery rates for an enterprise, a better experience for then insured (e.g., by limiting interactions with the insurer), etc. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises (e.g., an insurance company), embodiments may instead be associated with other types of enterprises in addition to and/or instead of those described herein (e.g., financial institutions, hospitals, etc.). Similarly, although certain types of resource request characteristics were described in connection some embodiments herein, other types of characteristics might be used instead of, or in addition to, those mentioned.

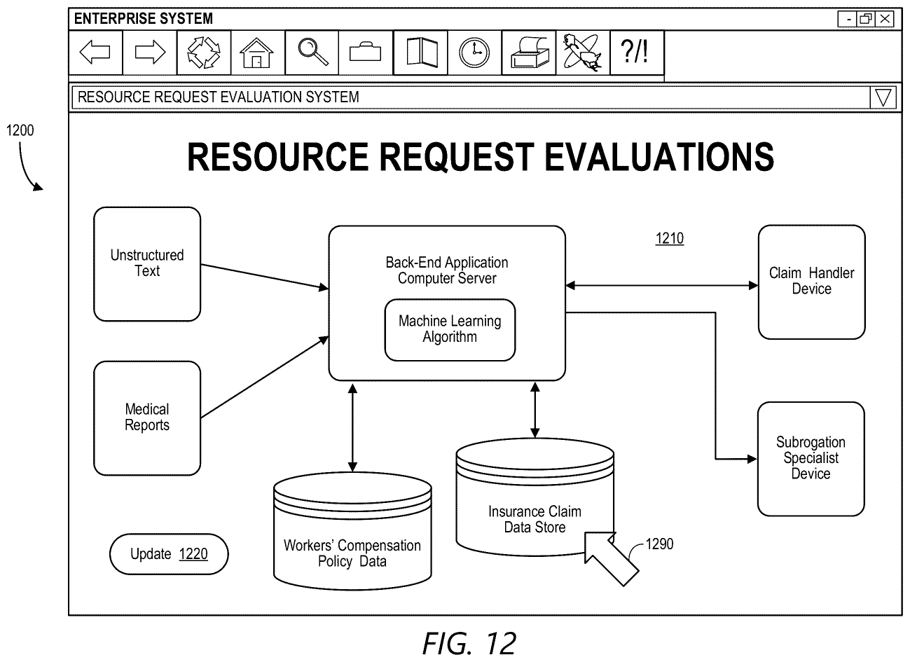

Note that the displays and devices illustrated herein are only provided as examples, and embodiments may be associated with any other types of interfaces. For example, FIG. 12 is an administrator or operator display 1200 including graphical representations of elements 1210 of a resource request evaluation system. Selection of a portion or element of the display 1200 might result in the presentation of additional information about that portion or device (e.g., a popup window presenting a more detailed view of data mappings, communication addresses for remote devices, or other specifics of the system implementation) or let an operator or administrator enter or annotate additional information about the resource request evaluation system (e.g., based on his or her experience and expertise). Selection of an “Update” icon 1220 (e.g., by touchscreen or computer mouse pointer 1290) might cause the system or platform to save changes, transmit insurance claim information to another party, etc. According to some embodiments a subrogation signal or alert may be automatically transmitted to a communication device (e.g., associated with a subrogation specialist) when a likelihood value moves beyond a threshold value.

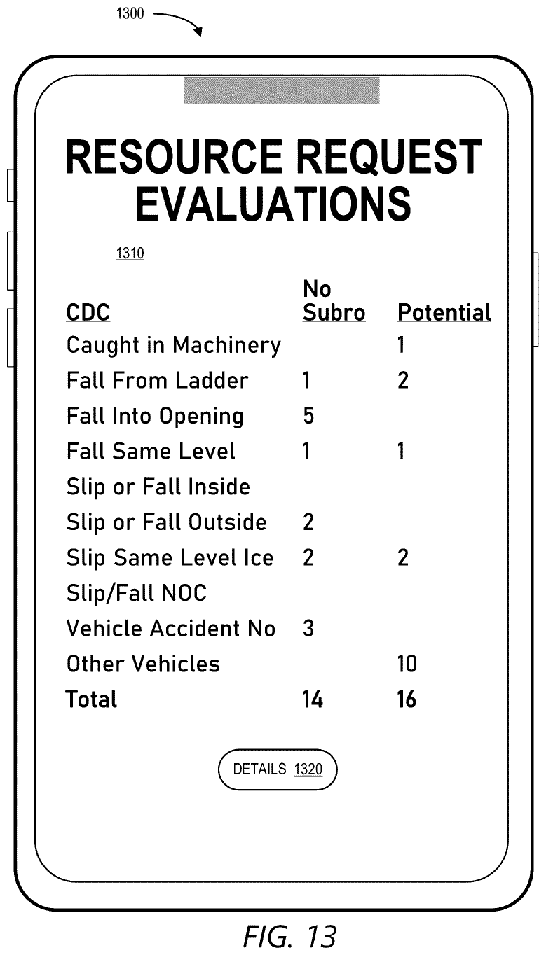

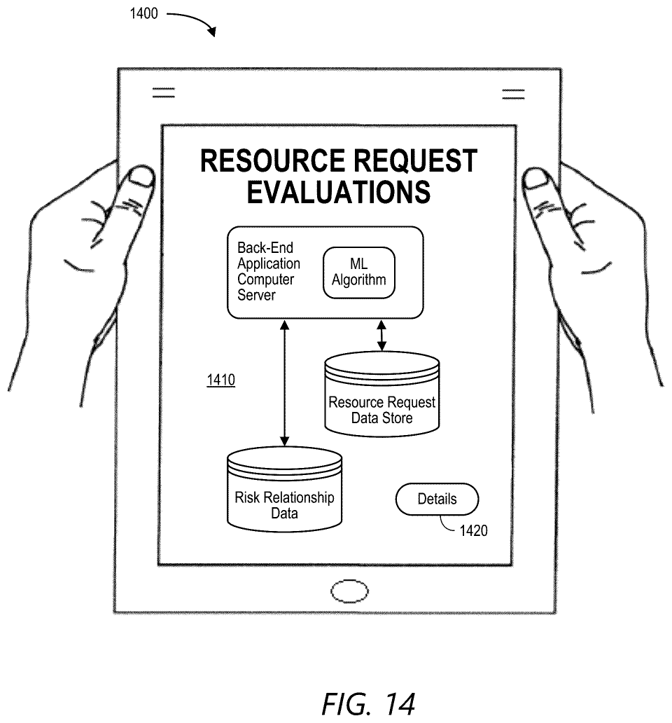

FIG. 13 illustrates a smartphone display 1300 according to some embodiments. The display 1300 includes a summary 1310 of subrogation evaluation results (e.g., broken down based on CDC codes). Selection of a “Details” icon 1320 might result in the display of underlying evaluation results. Similarly, FIG. 14 illustrates a handheld tablet display 1410 in accordance with some embodiments. The display 1410 includes a graphical representation of elements of subrogation evaluation system. Selection of a “Details” icon 1420 might result in the display of underlying request characteristics for insurance claims.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A resource request evaluation system implemented via a back-end application computer server, comprising:
(a) a resource request data store that contains electronic records connected to risk relationships with an insurer enterprise, each electronic record representing a resource request and including a resource request identifier and a plurality of request characteristics, wherein the risk relationships are a plurality of insurance policies and the resource request is an insurance claim;
(b) the back-end application computer server, coupled to the resource request data store, including:
a computer processor, and
a computer memory, coupled to the computer processor, storing instructions that, when executed by the computer processor cause the back-end application computer server to:
(i) retrieve, from the resource request data store, the request characteristics associated with a resource request for a first party,
(ii) based on the request characteristics and an initial set of business rules, automatically determine if the resource request for the first party should be immediately assigned to a request handler,
(iii) if the resource request is not to be immediately assigned to the request handler, arrange for the first party to answer a dynamic series of questions about the resource request,
(iv) based on answers provided by the first party and a set of investigation rules, automatically determine if the resource request for the first party should be assigned to the request handler or to a specialist to investigate whether another enterprise may be responsible for responding to the resource request, wherein the specialist is an insurance subrogation specialist and the other enterprise that may be responsible for responding to the insurance claim is another insurer,
(v) utilize a machine learning algorithm to evaluate resource requests currently assigned to the request handler to automatically determine if any of those resource requests should instead be routed to the specialist,
(vi) route the resource request to at least one of the request handler and the specialist,
(vii) update the machine learning algorithm based on the evaluation of the resource requests, the update improving functioning of the machine learning algorithm; and
(c) a communication port coupled to the back-end application computer server to facilitate an exchange of data with a remote resource request device to support an interactive graphical resource request display via a distributed communication network, wherein the interactive graphical resource request display is associated with graphical trend information and at least one of: (i) a referral rate, (ii) a success rate, (iii) a recovery rate, (iv) an expense ratio, and (v) a subrogation rate.

2. The system of claim 1, wherein the resource request characteristics include at least one of: (i) a first party identifier, (ii) a risk relationship identifier, and (iii) a claim description code.

3. The system of claim 1, wherein the series of questions is dynamically adjusted based on request characteristics and answers provided by the first party.

4. (canceled)

5. (canceled)

6. The system of claim 1, wherein the request handler is an insurance claim handler.

7. The system of claim 1, wherein the initial set of business rules is associated with at least one of: (i) a motor vehicle accident insurance claim, (ii) a slip or fall insurance claim, (iii) an insurance claim involving a third-party, and (iv) an insurance claim involving machinery.

8. The system of claim 1, wherein the retrieval performed by the back-end application is associated with at least one of: (i) a non-digital First Notice Of Loss (“FNOL”) intake process, and (ii) a digital FNOL intake process.

9. The system of claim 1, wherein the set of investigation rules will categorize the resource request as either “likely subrogation,” “potential subrogation,” and “no subrogation,” and resource requests categorized as “likely subrogation” or “potential subrogation” are routed to the insurance subrogation specialist.

10. (canceled)

11. The system of claim 1, wherein the insurance policies are associated with at least one of: (i) automobile insurance, (ii) property insurance, (iii) group benefits insurance, (iv) workers' compensation insurance, and (v) general liability insurance.

12. A computerized resource request evaluation method implemented via a back-end application computer server, comprising:
retrieving, by a computer processor of a back-end application computer server from a resource request data store, request characteristics associated with a resource request for a first party, wherein the resource request data store contains electronic records connected to risk relationships with an enterprise, and each electronic record represents a resource request and includes a resource request identifier and a plurality of request characteristics, wherein the enterprise is an insurer, the risk relationships are a plurality of insurance policies and the resource request is an insurance claim;
based on the request characteristics and an initial set of business rules, automatically determining if the resource request for the first party should be immediately assigned to a request handler;
if the resource request is not to be immediately assigned to the request handler, arranging for the first party to answer a dynamic series of questions about the resource request;
based on answers provided by the first party and a set of investigation rules, automatically determining if the resource request for the first party should be assigned to the request handler or to a specialist to investigate whether another enterprise may be responsible for responding to the resource request, wherein the specialist is an insurance subrogation specialist and the other enterprise that may be responsible for responding to the insurance claim is another insurer;
utilizing a machine learning algorithm to evaluate resource requests currently assigned to the request handler to automatically determine if any of those resource requests should instead be routed to the specialist;
routing the resource request to at least one of the request handler and the specialist;
updating the machine learning algorithm based on the evaluation of the resource requests, the update improving functioning of the machine learning algorithm; and
generating an interactive graphical resource request display associated with trend information and at least one of: (i) a referral rate, (ii) a success rate, (iii) a recovery rate, (iv) an expense ratio, and (v) a subrogation rate.

13. (canceled)

14. The method of claim 12, wherein the initial set of business rules is associated with at least one of: (i) a motor vehicle accident insurance claim, (ii) a slip or fall insurance claim, (iii) an insurance claim involving a third-party, and (iv) an insurance claim involving machinery.

15. The method of claim 12, wherein the retrieval performed by the back-end application is associated with at least one of: (i) a non-digital First Notice Of Loss (“FNOL”) intake process, and (ii) a digital FNOL intake process.

16. The method of claim 12, wherein the set of investigation rules will categorize the resource request as either “likely subrogation,” “potential subrogation,” and “no subrogation,” and resource requests categorized as “likely subrogation” or “potential subrogation” are routed to the insurance subrogation specialist.

17. (canceled)

18. A non-transitory, computer-readable medium storing instructions, that, when executed by a processor, cause the processor to perform a resource request evaluation method implemented via a back-end application computer server, the method comprising:
retrieving, by a computer processor of a back-end application computer server from a resource request data store, request characteristics associated with a resource request for a first party, wherein the resource request data store contains electronic records connected to risk relationships with an enterprise, and each electronic record represents a resource request and includes a resource request identifier and a plurality of request characteristics, wherein the enterprise is an insurer, the risk relationships are a plurality of insurance policies and the resource request is an insurance claim;
based on the request characteristics and an initial set of business rules, automatically determining if the resource request for the first party should be immediately assigned to a request handler;
if the resource request is not to be immediately assigned to the request handler, arranging for the first party to answer a dynamic series of questions about the resource request;
based on answers provided by the first party and a set of investigation rules, automatically determining if the resource request for the first party should be assigned to the request handler or to a specialist to investigate whether another enterprise may be responsible for responding to the resource request, wherein the specialist is an insurance subrogation specialist and the other enterprise that may be responsible for responding to the insurance claim is another insurer;
utilizing a machine learning algorithm to evaluate resource requests currently assigned to the request handler to automatically determine if any of those resource requests should instead be routed to the specialist;
routing the resource request to at least one of the request handler and the specialist;
updating the machine learning algorithm based on the evaluation of the resource requests, the update improving functioning of the machine learning algorithm; and
generating an interactive graphical resource request display associated with trend information and at least one of: (i) a referral rate, (ii) a success rate, (iii) a recovery rate, (iv) an expense ratio, and (v) a subrogation rate.

19. The medium of claim 18, wherein the resource request characteristics include at least one of: (i) a first party identifier, (ii) a risk relationship identifier, and (iii) a claim description code.

20. The medium of claim 18, wherein the series of questions is dynamically adjusted based on request characteristics and answers provided by the first party.

21. The system of claim 1, wherein the graphical trend information is a trend line for that at least one of the referral rate, the success rate, the recovery rate, the expense ratio and the subrogation rate.
